(19) United States
(12) Patent Application Publication
(10) Pub. No.: US 2025/0215286 A1
(43) Pub. Date: Jul. 3, 2025

(54) ADHESION MODIFIER COMPOSITION, AND CURABLE COMPOSITION AND METHOD OF BONDING INCLUDING THE SAME

(71) Applicant: 3M INNOVATIVE PROPERTIES COMPANY, St. Paul, MN (US)

(72) Inventor: Hae-Seung Harry Lee, Woodbury, MN (US)

(21) Appl. No.: 18/848,400

(22) PCT Filed: May 16, 2023
(86) PCT No.: PCT/IB2023/054998

§ 371 Date: Sep. 18, 2024

Related U.S. Application Data
(60) Provisional application No. 63/342,465, filed on May 16, 2022.

(51) Int. Cl. C09J 11/08; C08G 75/045; C09J 5/00

(52) U.S. Cl. CPC C09J 11/08; C08G 75/045; C09J 5/00

(57) ABSTRACT

An adhesion modifier composition comprises at least one of: Compound A represented by the formula (I) or Compound B represented by the formula (II), wherein a represents 1, 2, or 3; b is 1, 2, or 3; c is 0 or 1; c and d are independently 1 or 2; and e and f are independently 0 or 1, with the proviso that the sum c+d+e+f is 3 or 4. Each Z independently represents —S— or —Si(R²)₂—. R¹ represents an organic group composed of C, H, and optionally O atoms, and has a free valence of a+b. Each R² independently represents methyl or ethyl. Each L independently represents an alky lene group having from 2 to 6 carbon atoms. A curable composition including the adhesion modifier composition and a method of bonding two substrates using the curable composition are also disclosed.

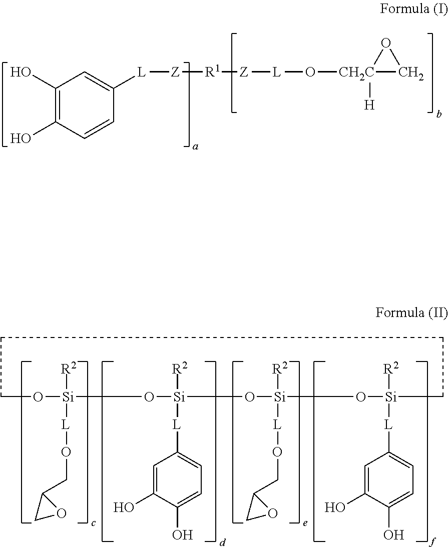

### BACKGROUND

Marine mussels are able to adhere to many materials such as, for example, metals, rocks, and even polytetrafluoroethylene. They are typically capable of securing themselves over wide temperature range (−40 to 40° C.), fluctuating salinities, humidity, and in the currents of marine environments. Mussel adhesive proteins are rich in the unusual amino acid 3,4-dihydroxyphenylalanine (DOPA), which contains a catechol group (shown generically below):

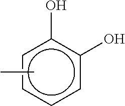

which has been thought to be responsible for the formation of adhesive surface bonding and cohesive crosslinks.

Various types of polymers carrying catechol groups have been prepared that contain catechol functional groups. Examples include polyacrylates, poly(ethylene glycol)s, and polystyrenes. These polymers have been used to develop adhesives for specialty applications.

### SUMMARY

There is a continuing need for adhesion modifier compositions (e.g., coupling agents) and adhesives having good adhesion to various surfaces.

The present disclosure provides such adhesion modifier and adhesives, which demonstrate improved adhesion to galvanized articles as compared to conventions adhesion modifiers/coupling agents.

In a first aspect, the present disclosure provides an adhesion modifier composition comprising at least one of:

Compound A represented by the formula:

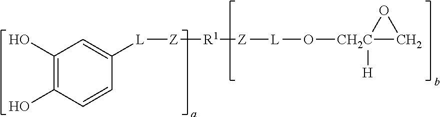

or Compound B represented by the formula:

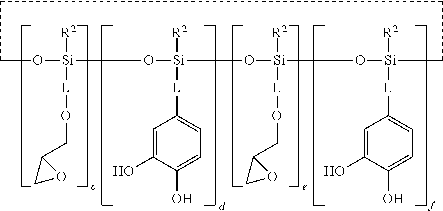

wherein:
Z represents —S— or —Si(R²)₂—;
a is 1, 2, or 3;
b is 1, 2, or 3;
R¹ represents an organic group composed of C, H, and optionally O atoms, and has a free valence of
   a+b;
c is 0 or 1;
R² represents methyl or ethyl;
L represents an alkylene group having from 2 to 6 carbon atoms;
c and d are independently 1 or 2;
   e and f are independently 0 or 1, with the proviso that the sum (c+d+e+f) is 3 or 4. In a second aspect, the present disclosure provides a curable composition comprising:
   at least one curable epoxy resin;
   the adhesion modifier composition according to the present disclosure; and
   an effective amount of curative for the epoxy resin.

In a third aspect, the present disclosure provides a method of bonding a first substrate to a second substrate, the method comprising
disposing a curable composition according to the present disclosure between, and in intimate contact with, the first and second substrates; and
at least partially curing the curable composition.

Features and advantages of the present disclosure will be further understood upon consideration of the detailed description as well as the appended claims.

### DETAILED DESCRIPTION

An adhesion modifier composition comprises at least one of Compound A and Compound B as described herein. The adhesion modifier composition may include Compound A but not Compound B, Compound B but not Compound A, or both Compound A and Compound B.

Compound is represented by the formula:

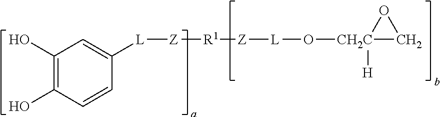

Each Z represents S (i.e., a sulfur atom) or SiR² (i.e., a silicon atom having two R² substituents and two free valence electrons).

Subscripts a and b are each independently 1, 2, or 3. The sum (a+b) may be 2, 3, 4, 5, or 6; preferably 3, 4, or 5; and more preferably 4.

R¹ represents an organic group composed of C, H, and optionally O atoms, and has a free valence equal to the quantity (a+b).

Consistent with IUPAC nomenclature, as used herein, the prefix “ylo” indicates a radical formed by removal of a hydrogen atom. For example, the radical “ylomethylbenzene” is equivalent to “benzyl”. Likewise, the suffix “yl” indicates a radical center.

Exemplary divalent groups R¹ include —CH₂CH₂OCH₂CH₂OCH₂CH₂—, —CH₂CH₂(OCH₂CH₂)₂OCH₂CH₂—, —CH₂CH₂(OCH₂CH₂)₂OCH₂CH₂—, p-phenylene, alkylene groups having from 1 to 18 carbon atoms (e.g., methylene, ethane-1,2-diyl, propane-1,3-diyl, butane-1,4-diyl, pentane-1,5-diyl, hexane-1,6-diyl, octane-1,8-diyl, decane-1,10-diyl, hexadecan-1,14-diyl, octadecan-1-18-diyl, cyclohexan-1,2-diyl, 2.2-dimethylpropanc-1,3-diyl, 3.4-dimethoxybutane-1.2-diyl, 2-methylcyclohexane-2.3-diyl, 1.2-bis(ylomethyl)benzene, 1.3-bis(ylomethyl)benzene, 1.4-bis(ylomethyl)- benzene, 2,5-toluenediyl, 3.4-toluenediyl, 1,3-di(p-methoxyphenyl)propane-2.2-diyl, 1.3-diphenyl- propane-2.2-diyl, phenylmethane-1.1-diyl and 2.4-di(4′-ylophenyl)pentane, 1.2-bis(2′yloethyl)benzene, 1.3-bis(2′-yleethyl)benzene, 1.4-bis(2′-yloethyl)benzene, 1.2.3-tris(ylomethylthio)benzene, 1.2,4- tris(ylomethylthio)benzene, 1.3.5-tris(ylomethylthio)benzene, 1.2,3-tris(2′-yloethylthio)benzene, 1,2,4- tris(2′-yloethylthio)benzene and 1.3.5-tris(2′-yloethylthio)benzene as well as their nuclear alkylated derivatives, bistylomethyl)sulfide, bis(2-yloethyl)sulfide, bis(3-ylopropy l)sulfide, bis(2-y loethylthio)- methane, bis(3-ylopropy lthio)methane, 1.2-bis(2′-yloethylthio)ethane, 1.2-bis(3′-ylopropylthio)ethane. 1.3-bis(2′-vloethylthio)propane, 1.3-bis(3′-vlopropylthio)propane, 4,8-chylomethyl-3,6,9-triyloundecane- 1.11-diyl, 4.7-diylomethyl1-3,6,9-trithiaundecane-1,11-diyl, 5, 7-diylomethyl-3,6,9-trithaundecane-1,11- diyl, tetrakis(2-yloethylthiomethyl)methane, tetrakis(3-y lopropy Ithomethyl)methane, bis(2.3- 30 diy lopropyl)sulfide, bis(1,3-diylopropyl)sulfide, 2,5-chylo-1,4-dithiane, 2.5-diylomethyl-1,4-chthiane. 2,5- diylomethyl-2.5-dimethyl-1.4-dithiane, bis(2-y locthyl) disulfide, and bis(3-ylopropyl) disulfide.

Exemplary trivalent groups R¹ include propane-1.2.3-triyl, benzene-1,3,5-triyl, 1.3.5-triazine- 2,4,6-triyl, 1.2.3-tris(2′-yloethylthio)propane, 1,2,3-tris(3′ylopropylthio)propane, 1,2-bis [(2′- yloethyl)thio]-propan-3-yl, and tris(3-y lopropylcarbonyloxymethyl)propane.

Exemplary tetravalent groups R¹ include tetrakis(3-y lopropylcarbonyloxymethyl)methane, benzene-1,2,4,5-tetrayl, tetrakis(ylomethyl)methane, butane-1,2,2,3-tetrayl, and octane-1,2,7,8-tetrayl. Exemplary pentavalent groups R¹ include cycloheptane-1, 2,3,5,6-pentayl, nonane-1, 2,4, 7,9- pentayl, and 4-methylhexane-1,2,3,4,5-pentayl.

Exemplary hexavalent groups R¹ include bexane-1,2,3,3,4,4-hexayl, ethane-1,1,1,2,2,2-hexayl, beptane-1,2,3,5,6,7-bexayl, triphenylene-1,2,6,7,9,11-hexayl, and nonane-1,2,4,6,8,9-hexayl.

R² represents methyl or ethyl, preferably methyl.

L represents an alkylene group having from 2 to 6 carbon atoms. Exemplary groups L include ethylene (i.e., ethane-1,2-diyl), propylene (e.g., propane-1,3-diyl), butylene (e.g., butane-1,4-diyl), pentylene (e.g., pentane-1,5-diyl), and hexylene (e.g., hexane-1,6-diyl). Of these, ethane-1,2-diyl and propane-1,3-diyl are often desirable.

In the case that Z is a sulfur atom, Compound A can be prepared, for example, by a thiol-ene reaction of a polythiol with a vinyl-or vinylalkyl-substituted catechol and a vinyl- or vinylalkyl glycidyl ether. Exemplary conditions are given in the examples hereinafter. Many suitable polythiols and vinyl- or vinylalkyl-substituted catechols are known in the art and many are available from commercial suppliers such as Sigma-Aldrich Chemical Co., Saint Louis, Missouri.

Exemplary polythiols include HSCH₂CH₂OCH₂CH₂OCH₂CH₂SH, HSCH₂CH₂(OCH₂CH₂)₂OCH₂CH₂SH, HSCH₂CH₂(OCH₂CH₂)₂OCH₂CH₂SH, 1,4- dimercaptobenzene, alkanedithiols having from 1 to 18 carbon atoms (e.g., methanedithiol, ethane-1,2- dithiol, propane-1,3-dithiol, butane-1,4-dithiol, pentane-1,5-dithiol, hexane-1,6-dithiol, octane-1,8-dithiol, decane-1,10-dithiol, hexadecan-1,14-dithiol, octadecan-1,18-dithiol, cyclohexan-1,2-dithiol, 2,2- dimethylpropane-1,3-dithiol, 3,4-dimethoxy butane-1,2-dithiol, 2-methylcyclohexane-2,3-dithiol, 1,2- bis(mercaptomethyl)benzene, 1,3-bis(mercaptomethyl)benzene, 1,4-bis(mercaptomethyl)benzene, 2,5- toluenedithiol, 3,4-toluenedithiol, 1,3-di(p-methoxyphenyl)propane-2,2-dithiol, 1,3-diphenylpropane-2,2- dithiol, phenylmethane-1,1-dithiol and 2,4-di(4′-mercaptophenyl)pentane, 1,2-bis(2′- mercaptoethyl)benzene, 1,3-bis(2′-mercaptoethyl)benzene, 1,4-bis(2′-mercaptoethyl)benzene, 1,2,3- tris(mercaptomethylthio)benzene, 1,2,4-tris(mercaptomethylthio)benzene, 1,3,5- tris(mercaptomethylthio)benzene, 1,2,3-tris(2′-mercaptoethylthio)benzene, 1,2,4-tris(2′- mercaptoethylthio)benzene and 1,3,5-tris(2′-mercaptoethyltho)benzene as well as their nuclear alkylated derivatives, bis(mercaptomethyl)sulfide, bis(2-mercaptoethyl)sulfide, bis(3-mercaptopropyl) sulfide, bis(2-mercaptoethyltho)methane, bis(3-mercaptopropylthio)methane, 1,2-bis(2′- mercaptoctbylthiojethane, 1,2-bis(3′-mercaptopropylthio)ethane, 1,3-bis(2′-mercaptoethylthio)propane. 1,3-bis(3′-mercaptopropylthio)propane, 4,8-dimercaptomethyl-3,6,9-trimercaptoundecane-1,11-dithiol, 4,7-dimercaptomethyl-3,6,9-trithiaundecane-1,11-dithiol, 5,7-dimercaptomethyl-3,6,9-tritlaundecane- 1,11-dithiol, tetrakis(2-mercaptoethylthomethyl)methane, tetrakis(3-mercaptopropylthiomethyl)methane, bis(2,3-dimercaptopropyl)sulfide, bis(1,3-dimercaptopropyl)sulfide, 2,5-dimercapto-1,4-dithiane, 2,5- dimercaptomethyl-1,4-dithiane, 2,5-dimercaptomethyl-2,5-dunethyl-1,4-dithane, bis(2-mercaptoethyl) disulfide, and bis(3-mercaptopropyl)disulfide.

Exemplary trivalent groups R¹ include propane-1,2,3-trithiol, benzene-1,3,5-trithiol, 1,3,5- triazine-2,4,6-trithiol, 1,2,3-tris(2′-mercaptoethylthio)propane, 1,2,3-tris(3′-mercaptopropylthio)propane, 1.2-bis [(2′-mercaptoctbyl)thio]-propan-3-thiol, and tris(3-mercaptopropylcarbonyloxymethyl)propane,

Exemplary tetravalent groups R¹ include tetrakis(3-mercaptopropylcarbonyloxymethyl)methane, benzene-1,2,4,5-tetrathiol, tetrakis(mercaptomethyl)methane, butane-1,2,2,3-tetrathiol, and octane- 1,2,7,8-tetrathio.

Exemplary pentavalent groups R¹ include cycloheptane-1,2,3,5,6-pentathiol, nonane-1,2,4,7,9- pentathiol, and 4-methylhexane-1,2,3,4,5-pentathiol.

Exemplary hexavalent groups R¹ include hexane-1,2,3,3,4,4-hexathiol, ethane-1.1.1.2.2.2- hesathiol, heptane-1,2,3,5,6, 7-hexathiol, triphenylene-1,2,6,7,9,11-hexathiol, and nonane-1,2,4,6,8,9- hexathiol.

In the case that Z is SiR², Compound A can be prepared, for example, by hydrosilylation of a corresponding compound having a plurality of —SiR²₂H groups with vinyl- or vinylalkyl-substituted catechol(s) and glycidyl ether(s).

Suitable vinyl- or vinylalkyl-substituted catechols are known in the art and many are available from commercial suppliers such as, for example, Gelest, Inc. or Morrisville Pennsylvania and Sigma-Aldrich Chemical Co., Saint Louis, Missouri. Examples include 4-vinylcatechol and 4-allylcatechol (also known as 4-allylcatechol). Others can be made according to known methods and/or obtained from commercial sources.

Suitable vinyl or vinylalkyl glycidyl ethers are known in the art and many are available from commercial suppliers such as, for example, Sigma-Aldrich Chemical Co., Saint Louis, Missouri. Examples include vinyl glycidyl ether and allyl glycidyl ether. Others can be made according to known methods and/or obtained from commercial sources.

Exemplary commercially available compounds having a plurality of —SiR²₂H groups include compounds represented by the formula:

R¹(Si(R²)₂H)_{(a+b)}
wherein R¹, R², a, and b are as previously described.

Examples include bis(dimethylhydrosilyl)methylene, bis(diethylhydrosilyl)-1,2-ethylene, bis(dimethylhydrosilyl)-1,3-propylene, bis(dimethylhydrosilyl)-1,4-butylene, bis(dimethylhydrosilyl)phenylene, α,ωbis(dimethylhydrosilyl)polydimethylsiloxanes, 1,4(dimethylhydrosilyl)dihydronaphthalene, and tris(dimethylhydrosilyl)benzene.

Hydrosilanes may be synthesized by hydride reduction of corresponding chloro- or alkoxysilanes using reactive metal hydrides such as lithium aluminum hydride (LiAlH₄), sodium borohydride, and diisobutylaluminum hydride (DIBAL-H), or they may be obtained from commercial sources, for example,

Hydrosilylation, also called catalytic hydrosilylation, describes the addition of Si—H bonds across unsaturated bonds. The hydrosilylation reaction may be catalyzed by a suitable catalyst (e.g., a platinum catalyst or a rhodium catalyst), and in some cases heat is applied to effect the curing reaction. In this reaction, the Si—H adds across the double bond to form new C—H and Si—C bonds. This process in described, for example, in PCT Publication No. WO 2000/068336 (Ko et al.), and PCT Publication Nos. WO 2004/111151 and WO 2006/003853 (Nakamura).

Useful hydrosilylation catalysts may include thermal catalysts and/or photocatalysts. Exemplary thermal catalysts include platinum complexes such as H₂PtCl₆ (Speier's catalyst); organometallic platinum complexes such as, for example, a coordination complex of platinum and a divinyldisloxane (Karstedt's catalyst); and chloridotris(triphenylphosphine)rhodium(I) (Wilkinson's catalyst).

Useful platinum photocatalysts are disclosed, for example, in U.S. Pat. No. 7,192,795 (Boardman et al.) and references cited therein. Certain preferred platinum photocatalysts are selected from the group consisting of Pt β-diketonate complexes (such as those disclosed in U.S. Pat. No. 5.145.886 (Oxman et al.)), (η5-cyclopentadienyl)tri(σ-aliphatic)platinum complexes (such as those disclosed in U.S. Pat. No. 4.916.169 (Boardman et al.) and U.S. Pat. No. 4.510,094 (Drahnak)), and C₇-₂₀-aromatic substituted (η5- cyclopentadienyl)tri(σ-aliphatic)platinum complexes (e.g., such as those disclosed in U.S. Pat. No. 6.150.546 (Butts)). Hydrosilylation photocatalysts are activated by exposure to actinic radiation, typically ultraviolet light, for example, according to known methods.

The amount of hydrosilylation catalyst used may be any effective amount for causing hydrosilylation. In some embodiments, the amount of hydrosilylation catalyst is in an amount of from about 0.5 to about 30 parts of platinum per million parts of the total weight of Si—H and vinyl group-containing compounds combined, although greater and lesser amounts may also be used. In some cases, mere mixing is sufficient. In other cases, heating and/or irradiation with ultraviolet light may be helpful.

In preparing Compound A, stochiometric amounts of each reagent should be adjusted to achieve the desired level of functionality in Compound A.

Compound B is a cyclic polysiloxane represented by the formula:

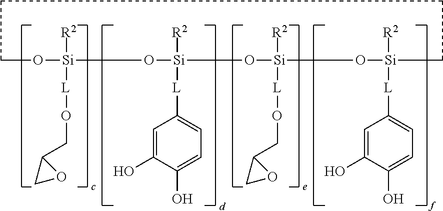

wherein:
R² and L are as previously defined;
c and d are independently 1 or 2; and
e and f are independently 0 or 1, with the proviso that the sum (c+d+e+f) is 3 or 4, preferably 4.

In the structure shown above, the dashed line connecting opposite ends indicates a covalent bond between O and Si atoms.

Compound B can be made, for example, by hydrosilylation of a cyclosiloxane having 3 or 4 Si—H groups with one or more alkenyl glycidyl ether (especially vinyl or allyl glycidyl ether), one or more alkenyl catechol (especially 4-vinylcatechol or 4-allylcatechol), and 1,3,5,7-tetramethylcyclotetrasiloxane, 1,3,5,7-tetraethylcyclotetrasiloxane, 1,3,5-trimethylcyclotrisiloxane, or 1,3,5-trimethylcyclotrisiloxane. Such cyclosiloxanes can be prepared by known procedures and/or obtained from commercial suppliers Stochiometric amounts of each reagent should be adjusted to achieve the desired level of functionality in Compound B.

The adhesion modifier composition may further comprise additional components such as, for example, wetting agents, antioxidants, and organic solvent(s). Suitable organic solvents may include, for example, hydrocarbons (e.g., benzene, toluene, xylene, pentane, hexane, heptane, octane, decane, dodecane, or cyclohexane), esters (e.g., ethyl acetate, propyl acetate, or butyl acetate), ethers (e.g., diether ether, t-butyl methyl ether, tetrahydrofuran, glyme, or diglyme), chlorocarbons (e.g., dichloromethane, chloroform, carbon tetrachloride, or dichloroethane), ketones (e.g., acetone, methyl ethyl ketone), and combinations thereof. The amount of optional organic solvent is typically adjusted to achieve desired properties (e.g., viscosity and/or dried coating weight).

The adhesion modifier composition can be combined with at least one curable epoxy resin (i.e., an epoxy resin) and a curative for the epoxy resin to provide a curable composition.

The amount of adhesion modifier composition in the curable composition is not particularly limited, but is typically in an amount of from 0.01 to 10 weight percent of the curable composition, preferably 0.05 to 5 weight percent of the curable composition, and more preferably 0.1 to 3 weight percent of the curable composition.

The epoxy resin can include linear polymeric epoxides having terminal epoxy groups (e.g., a diglycidyl ether of a polyoxyalkylene glycol), polymeric epoxides having skeletal epoxy groups (e.g., polybutadiene poly epoxy), polymeric epoxides having pendant epoxy groups (e.g., a glycidyl methacry late polymer or copolymer), or a mixture thereof.

Examples of useful epoxy resins include glycidated resins, cycloaliphatic resins, and epoxidized oils. The glycidated resins can be the reaction product of a glycidyl ether, such as epichlorohydrin, and a bisphenol compound such as bisphenol A. Various examples of epoxy resins include C₄-C₂₈ alkyl glycidyl ethers; C₂-C₂₈ alkyl- and alkenyl-glycidyl esters; C₁-C₂₈ alkyl-, mono- and poly-phenol glycidyl ethers; polyglycidyl ethers of pyrocatechol, resorcinol, hydroquinone, 4,4′- dihydroxydiphenylmethane (or bisphenol F), 4,4′-dihydroxy-3,3′-dimethyldiphenylmethane, 4,4′- dihydroxydiphenyldimethylmethane (or bisphenol A), 4,4′-dihydroxydiphenylmethylmethane, 4,4′- dihydroxydiphenylcyclohexane, 4,4′-dihydroxy-3,3′-dimethyldiphenylpropane, 4,4′- dihydroxydiphenylsulfone, and tris (4-hydroxyphenyl)methane; polyglycidyl ethers of the chlorination and bromination products of the above-mentioned diphenols; polyglycidyl ethers of novolacs; polyglycidyl ethers of diphenols obtained by esterifying ethers of diphenols obtained by esterifying salts of an aromatic hydrocarboxylic acid with a dihaloalkane or dihalogenated dialkyl ether; polyglycidyl ethers of polyphenols obtained by condensing phenols and long-chain halogen paraffins containing at least two halogen atoms; N,N′-diglycidylaniline; N,N′-dimethyl-N,N′-diglycidyl-4,4′-diaminodiphenyl methane; N,N,N′,N′-tetraglycidyl-4.4′-diaminodiphenyl methane; N,N′-diglycidyl-4-aminophenyl glycidyl ether; N,N,N′,N′-tetraglycidyl-1,3-propylene bis(4-aminobenzoate); phenol novolac epoxy resin; cresol novolac epoxy resin; and combinations thereof.

Suitable epoxy compounds may include, for example, aliphatic (including cycloaliphatic) and aromatic epoxy compounds. The epoxy compound(s) may be monomeric, oligomeric, or polymeric epoxides, or a combination thereof. The epoxy resin may be a pure compound or a mixture comprising at least two epoxy compounds. The epoxy resin typically has, on average, at least 1 epoxy (i.e., oxiranyl) group per molecule, preferably at least about 1.5 and more preferably at least about 2 epoxy groups per molecule. In some cases, 3, 4, 5, or even 6 epoxy groups may be present, on average. Polymeric epoxides include linear polymers having terminal epoxy groups (e.g., a diglycidyl ether of a polyoxyalkylene glycol), polymers having skeletal oxirane units (e.g., polybutadiene polyepoxide), and polymers having pendent epoxy groups (e.g., a glycidyl methacry late polymer or copolymer). Other useful epoxy resins are poly hydric phenolic formaldehyde condensation products as well as polyglycidyl ethers that contain as reactive groups only epoxy groups or hydroxy groups. The “average” number of epoxy groups per molecule can be determined by dividing the total number of epoxy groups in the epoxy- containing material by the total number of epoxy-containing molecules present.

The choice of epoxy resin may depend upon the intended end use. For example, epoxides with flexible backbones may be desired where a greater amount of ductility is needed in the bond line. Materials such as diglycidyl ethers of bisphenol A and diglycidyl ethers of bisphenol F can help impart desirable structural adhesive properties upon curing, while hydrogenated versions of these epoxies may be useful for compatibility with substrates having oily surfaces.

Commercially available epoxy compounds include octadecylene oxide, epichlorohydrin, styrene oxide, vinylcyclohexene oxide, glycidol, glycidyl methacry late, vinylcyclohexene dioxide, 3.4- epoxycyclohexylmethyl-3,4-epoxycyclohexenecarboxylate, 3,4-epoxy-6-methylcyclohexylmethyl-3,4- epoxy-6-methylcyclohexene carboxylate, bis(3,4-epoxy-6-methylcyclohexylmethyl) adipate. bis(2,3- epoxycyclopentyl) ether, dipentene dioxide, silicone resin containing epoxy functionality, flame retardant epoxy resins (e.g., DER-580, a brominated bisphenol type epoxy resin available from Dow Chemical Co.), 1,4-butanediol diglycidyl ether of phenol-formaldehyde novolac (e.g., DEN-431 and DEN-438 from Dow Chemical Co.), and resorcinol diglycidyl ether (e.g., Kopoxite from Koppers Company. Inc.). bis(3.4-epoxycyclohexyl)adipate, 2-(3,4-epoxycyclohexyl-5,5-spiro-3,4-epoxy) cyclohexene metadioxane, vinylcyclohexene monoxide 1,2-epoxyhexadecane, alkyl glycidyl ethers such as (e.g., HELOXY Modifier 7 from Momentive Specialty Chemicals. Inc., Waterford, New York), alkyl C12-C14 glycidyl ether (e.g., HELOXY Modifier 8 from Momentive Specialty Chemicals, Inc.), butyl glycidyl ether (e.g., HELOXY Modifier 61 from Momentive Specialty Chemicals, Inc.). cresyl glycidyl ether (e.g., HELOXY Modifier 62 from Momentive Specialty Chemicals, Inc.), p-tert-butylphenyl glycidyl ether (e.g., HELOXY Modifier 65 from Momentive Specialty Chemicals, Inc.), polyfunctional glycidyl ethers such as diglycidyl ether of 1,4-butanediol (e.g., HELOXY Modifier 67 from Momentive Specialty Chemicals, Inc.), diglycidyl ether of neopentyl glycol (e.g., HELOXY Modifier 68 from Momentive Specialty Chemicals. Inc.), diglycidyl ether of cyclohexanedimethanol (e.g., HELOXY Modifier 107 from Shell Chemical Co.), trimethylolethane triglycidyl ether (e.g., HELOXY Modifier 44 from Momentive Specialty Chemicals, Inc.), trimethylolpropane triglycidyl ether (e.g., HELOXY Modifier 48 from Momentive Specialty Chemicals, Inc.), polyglycidyl ether of an aliphatic polyol (e.g., HELOXY Modifier 84 from Momentive Specialty Chemicals, Inc.), polyglycol diepoxide (e.g., HELOXY Modifier 32 from Momentive Specialty Chemicals, Inc.), bisphenol F epoxides, 9,9-bis[4-(2,3-epoxypropoxy)- phenyl]fluorenone (e.g., Epon 1079 from Momentive Specialty Chemicals, Inc.).

In some embodiments, the epoxy resin contains one or more epoxy compounds having an epoxy equivalent weight of from 100 g/mole to 1500 g/mol. More preferably, the epoxy resin contains one or more epoxy compounds having an epoxy equivalent weight of from 300 g/mole to 1200 g/mole. Even more preferably, the curable composition contains two or more epoxy compounds, wherein at least one epoxy resin has an epoxy equivalent weight of from 300 g/mole to 500 g/mole, and at least one epoxy resin has an epoxy equivalent weight of from 1000 g/mole to 1200 g/mole.

Useful epoxy resins may also include aromatic glycidyl ethers, e.g., such as those prepared by reacting a polyhydric phenol with an excess of epichlorohydrin, cycloaliphatic glycidyl ethers.

hydrogenated glycidyl ethers, and mixtures thereof. Such polyhydric phenols may include resorcinol, catechol, hydroquinone, and the polynuclear phenols such as p,p′-dihydroxy dibenzyl, p,p′- dihydroxy diphenyl, p,p′-dihydroxyphenyl sulfone, p,p′-dihydroxy benzophenone, 2,2′-dihydroxy-1,1- dinaphthylmethane, and the 2,2′-, 2,3′-, 2,4′-, 3,3′-, 3,4′-, and 4,4′-isomers of dihydroxydiphenylmethane, dihydroxydiphenyldimethylmethane, dihydroxydiphenylethylmethylmethane, dihydroxydiphenylmethylpropylmethane, dihydroxydiphenylethylphenylmethane, dihydroxydiphenylpropylphenylmethane, dihydroxydiphenylbutylphenylmethane, dihydroxydiphenyltolylethane, dihydroxydiphenyltolylmethylmethane, dihydroxydiphenyl- dicyclohexylmethane, and dihydroxydiphenylcyclohexane.

Useful epoxy compounds may also include glycidyl ethers of bisphenol A, bisphenol F, and novolac resins as well as glycidyl ethers of aliphatic or cycloaliphatic diols. Examples of commercially available glycidyl ethers include diglycidyl ethers of bisphenol A such as those available as EPON 828, EPON 1001, EPON 1310, and EPON 1510 from Hexion Specialty Chemicals GmbH, Rosbach, Germany; those available under the trade name D.E.R. (e.g., D.E.R. 331, 332, and 334) from Dow Chemical Co., Midland, Michigan; those available under the trade name EPICLON from Dainippon Ink and Chemicals. Inc. (e.g., EPICLON 840) and 850) and those available under the trade name YL-980 from Japan Epoxy Resins Co., Ltd.); diglycidyl ethers of bisphenol F (e.g., those available under the trade name EPICLON from Dainippon Ink and Chemicals, Inc. (e.g., EPICLON 830)); glycidyl ethers of novolac resins (e.g., novolac epoxy resins, such as those available under the trade name D.E.N. from Dow Chemical Co. (e.g., D.E.N. 425, 431, and 438)); and flame retardant epoxy resins (e.g., D.E.R. 580, a brominated bisphenol type epoxy resin available from Dow Chemical Co.). In some embodiments, aromatic glycidyl ethers, such as those prepared by reacting a dihydric phenol with an excess of epichlorohydrin, may be preferred. In some embodiments, nitrile rubber modified epoxies may be used (e.g., KELPOXY 1341 available from CVC Chemical).

Low viscosity epoxy compound(s) may be included in the epoxy resin, for example, to reduce viscosity. Examples of low viscosity epoxy compounds include: cyclohexanedimethanol diglycidyl ether, resorcinol diglycidyl ether, p-tert-butylphenyl glycidyl ether, cresyl glycidyl ether, diglycidyl ether of neopentyl glycol, triglycidyl ether of trimethylolethane, triglycidyl ether of trimethylolpropane, triglycidyl p-aminophenol, N,N′-diglycidylaniline, N,N,N′,N′-tetraglycidyl m-xylylenediamine, and vegetable oil polyglycidyl ether.

Examples of suitable epoxy resins include bis-4,4′-(1-methylethylidene) phenol diglycidyl ether and (chloromethyl) epoxide bisphenol A diglycidyl ether. Commercially available epoxy resins that can be used in the practice of this invention include those sold under the trade designation ARALDITE by Huntsman Corporation. The Woodlands, Texas and EPON by Hexion Inc., Columbus, Ohio. Suitable epoxy resins also include glycidyl ethers of trihydric phenols such as tris(hydroxyphenyl) methane. Such resins are commercially available under the trade designation TACTIX by Huntsman Corporation.

In some embodiments, an epoxy novolac resin may be used. In some embodiments, the multifunctional epoxy resins include a tetrafunctional epoxy resin based on meta-xylenediamine, such as those sold under the trade designation ERISYS by Emerald Performance Materials LLC, Vancouver, Washington.

It can be advantageous to use a mixture of epoxy resins whose constituents are selected to provide the desired viscosity characteristics before curing. In some embodiments, the multifunctional epoxy resin includes a trifunctional epoxy resin, such as triphenylmethane triglycidyl ether, or other glycidyl ether with three or more epoxide groups per molecule. The trifunctional epoxy resin is, in some instances, a solid epoxy resin at ambient temperature. Optionally, the trifunctional epoxy resin is blended with a tetrafunctional epoxy resin, such as 44′-methylenebis(N,N-diglycidylaniline). The difunctional epoxy resin can be a bisphenol A/epichlorohydrin derived liquid epoxy resin, or other glycidyl ether with two epoxide groups per molecule.

The relative amounts of multifunctional epoxy resin and difunctional epoxy resin can be adjusted to obtain suitable crosslink density, which in turn affects important adhesive properties such as glass transition temperature, tensile strength, and shear strength. Low viscosity difunctional epoxy resins in suitable amounts can also help the uncured adhesive flow and wet the bonding surfaces of a substrate for improved bond strength.

The epoxy resin or resins can have any suitable molecular weight. The weight average molecular weight can be from 100 grams per mole (g/mol) to 50,000 g/mol, from 175 to 20000 g/mol, from 250 to 10000 g/mol, or in some embodiments less than, equal to, or greater than 100, 125, 150, 175, 200, 250, 300, 350, 400, 450, 500, 550, 600, 650, 700, 750, 800, 850, 900, 950, 1000, 2000, 5000, 7000, 10000. 20000, 30000, 40000, or even 50000 g/mol.

The curable composition often includes at least 20 weight percent epoxy resin based on a total weight of the curable composition, although lower amounts are permissible. For example, the curable composition can include at least 25, at least 30, at least 40, or even at least 50 weight percent of epoxy resin. The curable composition can include up to 70, 80, or even 90 weight percent epoxy resin, for example.

In some embodiments, the curable composition further includes filler. Examples of useful fillers include naturally occurring or synthetic materials such as silicon dioxide (e.g., fumed silica); nitrides (e.g., silicon nitride); glasses and fillers derived from, for example, Zr, Sr, Ce, Sb, Sn, Ba, Zn, and Al; feldspar; borosilicate glass; zirconia; titania; and micrometer and sub-micrometer fumed silica particles (e.g., pyrogenic silicas such as those available under the trade designation AEROSIL, including “OX 50,” “130,” “150” and “200” silicas from Degussa Corp., Akron, Ohio and CAB-O-OSIL M5 silica from Cabot Corp., Tuscola, Illinois), and combinations thereof. Useful filler may also include core-shell rubber particles. Core-shell rubber particles are filler particles having two or more distinct concentric parts: a core and at one or more shell layers surrounding an elastomeric core.

Filler can be present in any suitable amount. The filler can be from 10 to 60 weight percent. from 12 to 45 weight percent. from 15 to 30 weight percent, or in some embodiments, less than, equal to, or greater than 10, 12, 15, 17, 20, 25, 30, 35, 40, 45, 50, 55, or even 60 weight percent. based on the total weight of the curable composition.

The curable composition optionally contains one or more reactive diluents. Reactive diluents, which lower the viscosity of the epoxy resin components, are generally epoxy resins having either a branched aliphatic backbone that is saturated or a cyclic backbone. Examples of reactive diluents include, but are not limited to, the diglycidyl ether of resorcinol, the diglycidyl ether of cyclohexanedimethanol, the diglycidyl ether of neopentyl glycol, and the triglycidyl ether of trimethylolpropane. Diglycidyl ethers of cyclohexanedimethanol are commercially available under the trade designation HELOXY MODIFIER 107 from Hexion Specialty Chemicals in Columbus, Ohio and under the trade designation EPODIL 757 from Evonik Industries AG, Essen, Germany.

Reactive diluents may be added in suitable amounts to obtain a desired viscosity profile for the uncured shimming adhesive. Typical amounts can be from 1 percent to 12 percent by weight based on the total weight of the epoxy resin. Further details of reactive diluents can be found in, for example, PCT Publication No. WO 2014/210298 (Elgimiabi et al.).

The curable composition comprises an effective amount of curative (i.e., one or more curatives) for the epoxy resin. As used herein, the term effective amount refers to any amount that is sufficient to at least substantially cure the epoxy resin, optionally in combination with heat or electromagnetic radiation. Useful curatives may comprise a single compound or a mixture of at least two compounds.

Any curative capable of curing the epoxy resin(s) may be included as a curative, for example. By the term “curative” is meant one or more reactive components capable of either reacting with an epoxy functional group and/or polymerizing the epoxy functional group. Preferably, the curative comprises a latent curative that is activated by heating (e.g., to at least 40° C., at least 50° C., or even at least 60° C.) and/or by exposure to actinic radiation (e.g., visible and/or ultraviolet light).

The curative is often included in amounts of from about 5 to about 45 parts, desirably from about 1 to about 30 parts, more desirably from about 10 to about 20 parts by weight per 100 parts of the epoxy resin, although this is not a requirement. Preferably, any thermally activatable amine curative is present in an amount of 0.5 to 30 percent by weight. more preferably 1 to 15 percent by weight, based on the total weight of the curable composition.

Examples of suitable curatives include guanidines, substituted guanidines, substituted ureas, melamine resins, guanamine derivatives, blocked polyamines, aromatic polyamines, and/or mixtures thereof. The curative may be involved stoichiometrically in the curing reaction; it may, however, also be catalytically active. Examples of suitable substituted guanidines are methylguanidine, dimethylguanidine, trimethylguanidine, tetramethylguanidine, methylisobiguanidine, dimethylisobiguanidine, tetramethylisobiguanidine, hexamethylisobiguanidine, heptamethylisobiguanidine, and cyanoguanidine (dicyandiamide). Examples of suitable guanamine derivatives which may be mentioned are alkylated benzoguanamine resins, benzoguanamine resins or methoxy methylethoxy methylbenzoguanamine.

Exemplary curatives also include substituted imidazoles (e.g., 1-N-substituted imidazoles and 2-C-substituted imidazoles and metal imidazolate salts as described in U. S. Pat. No. 4,948,449 (Tarbutton et al.)), substituted ureas, substituted hydrazides (e.g., aminodihydrazide, adipic dihydrazide, isophthalyl dihydrazide), substituted guanidines (e.g., tetramethyl guanidine), primary and/or secondary polyamines, diaminodiaryl sulfones (e.g., diaminodiphenyl sulfone), polythiols, and combinations thereof.

Additional examples of suitable curatives include monomeric and oligomeric amine-functional polyarylenes, wherein between the arylene groups are simple covalent bridges such as in the diaminodiphenyls, or connecting groups selected from the group consisting of alkylene of from 1-8 carbon atoms, ether, sulfone, ketone, carbonate, carbonyl, carboxylate, carboxamide, and combinations thereof. Examples include 3,3′-diaminodiphenylsulfone and 4,4′-diaminodiphenylsulfone.

Commercially available curatives include, for example, ANCAMINE CG-1400 micronized dicyandiamide from Air Products and Chemicals Incorporated, Allentown, Pennsylvania; those available CUREZOL 2PHZ-S and CUREZOL 2MA-OK also from Air Products and Chemicals; ARADUR 3123 from Huntsman Advanced Materials. The Woodlands, Texas; and as OMICURE U-35 and OMICURE U-52 from CVC Thermoset Specialties, Moorestown, New Jersey.

Exemplary thermally activatable amine curatives should be substantially inactive at room temperature but be capable of activation at elevated temperature, preferably above about 50° C. to 120° C. or higher, depending on the system and application, to effect curing of the one-part thermally curable composition. Suitable thermally activatable amine curatives are described in British Patent 1, 121, 196 (Ciba Geigy AG), European Patent Application 138465A (Ajinomoto Co.) and European Patent Application 193068A (Asahi Chemical). Other suitable thermally activatable amine curatives include a reaction product of (i) a polyfunctional epoxy compound, (ii) an imidazole compound such as 2-ethyl-4-methylimidazole and (iii) phthalic anhydride. The polyfunctional epoxy compound may be any compound having two or more epoxy groups in the molecule as described in U. S. Pat. No. 4,546,155 (Hirose et al.). Other suitable thermally activatable amine curatives are those given in U.S. Pat. No. 5,077,376 (Dooley). Additional thermally activatable amine curatives include 2-heptadeoy limidazole, 2- phenyl-4,5-dihydroxymethylimidazole, 2-phenyl-4-methyl-5-hydroxymethylimidazole, 2-phenyl-4- benzyl-5-hydroxymethylimidazole, 2,4-diamino-8-2-methylimidazolyl-(1)-ethyl-5-triazine, and addition products of triazine with isocyanuric acid, succinohydrazide, adipohydrazide, isophthalohydrazide, o-oxybenzohydrazide, and salicylohydrazide.

Commercially available thermally activatable amine curatives (also sometimes termed latent hardeners) include, for example, those having the trade designations: AMICURE MY-24. AMICURE GG-216, and AMICURE ATU CARBAMATE from Ajinomoto Fine-Techno Co., Inc., Kanagawa, Japan; NOVACURE HX-372 (commercially available from Asahi Kasei Kogyo K. K., Osaka, Japan); AJICURE such as, for example, grades PN-23 (100-105° C.), PN-H (120-125° C.), PN-31 (115-120° C.), PN-40 (105- 110° C.), and MY-H (125-130°C.) from Ajinomoto Fine-Techno Co., Inc.; encapsulated modified imidazoles such as those available as TECHNICURE LC-100 encapsulated modified imidazole (m.p.=90-100° C.) and TECHNICURE LC-80 encapsulated modified imidazole (m.p.=90-100° C.) from ACCI Specialty Materials, Linden, New Jersey; and latent amine curing agents available as FUJICURE FXR-1020 (m.p.=115-130° C.), FUJICURE FXR-1030 (m.p.=135-145° C.), FUJICURE FXR-1081 (m.p.=115-125° C.), FUJICURE FXR-1090FA (m.p.=110-120° C.), FUJICURE FXR-1121 (128-138° C.), SANCURE LC-125 (110-125° C.) from Sanho Chemical Co., Ltd., Kaohsiung City, Taiwan.

The curable composition may be formulated as a one-part or two-part composition as is common with many curable compositions comprising epoxy resin. If formulated as a two-part composition resin the epoxy resin and curative are generally kept apart in a Part A and Part B, respectively, which are combined immediately prior to use.

Curable compositions according to the present disclosure are useful to bonding a first substrate to a second substrate. As with typical thermosetting adhesives, the curable composition is typically applied to one substrate and then contacted with a second substrate and sufficiently cured to form an adhesive bond between the two substrates. Curing may be spontaneous (e.g., in the case of a two-part formulation) or may be facilitated by application of heat and/or electromagnetic radiation.

The curable composition may be applied using any suitable method including, for example, by a nozzle, roll, or brush.

Selection of appropriate cure conditions will typically depend on the curative selected, andi s within the capabilities of those of ordinary skilled in the art.

Exemplary substrates that can be bonded include glass, plastic, metal, wood, cloth, fiberglass, ceramic, and combinations thereof. Advantageously, the curable compositions containing the adhesion modifier composition can outperform (e.g., in T-peel testing) similar compositions that include a conventional coupling agent such as, for example, glycidoxypropyltrimethoxysilane instead, especially in the case of cold rolled steel and/or zinc substrates (e.g., galvanized metals).

Objects and advantages of this disclosure are further illustrated by the following non-limiting examples, but the particular materials and amounts thereof recited in these examples, as well as other conditions and details, should not be construed to unduly limit this disclosure.

### EXAMPLES

Unless otherwise noted, all parts, percentages, ratios, etc. in the Examples and the rest of the specification are by weight.

Table 1, below, reports abbreviations and materials used in the Examples.

TABLE 1

| ABBREVIATION | DESCRIPTION AND SOURCE |
|---|---|
| | Eugenol, obtained from MilliporeSigma, St. Louis, Missouri |
| TPFPB | Tris(pentafluorophenyl)borane, obtained from MilliporeSigma |
| TES | Triethylsilane, obtained from MilliporeSigma |
| AGE | Allyl glycidyl ether, obtained from MilliporeSigma |
| EDDET | 2,2′-(Ethylenedioxy)diethanethiol, obtained from MilliporeSigma |
| TMPTMP | Trimethylolpropane tris(3-mercaptopropionate), obtained from |
| | MilliporeSigma |
| PETMP | Pentaerythritol tetrakis(3-mercaptopropionate), obtained from |
| | MilliporeSigma |
| EA | Ethyl acetate, obtained from MilliporeSigma |
| VAZO 67 | 2,2′-azobis(methylbutyronitrile), obtained as VAZO 67 from |
| | MilliporeSigma |
| MeOH | Methanol, obtained from MilliporeSigma |
| AMBERLYST 15 | A macro reticular polystyrene based ion exchange resin with strongly |
| | acidic sulfonic group, obtained as AMBERLYST 15 HYDROGEN |
| | FORM DRY from MilliporeSigma |
| IRG 651 | 2,2-dimethoxy-2-phenylacetophenone, obtained as IRGACURE 651 from |
| | MilliporeSigma |
| BDMSB | 1,4-bis(dimethylsilyl)benzene, obtained from Gelest Inc., Morrisville, |
| | Pennsylvania |
| Pt. Cat. | Platinum divinyl tetramethyldisiloxane complex, 3% Pt in vinyl |
| | terminated PDMS, obtained as product number SIP6830.3 from Gelest, |
| | Inc. |
| TMCTS | 1,3,5,7-tetramethylcyclotetrasiloxane, obtained from Gelest, Inc. |
| CRS | Cold-rolled steel coupon, obtained from ACT Test Panels, Hillsdale, |
| | Michigan |
| HDGS | Hot dip galvanized steel coupon, obtained from ACT Test Panels |
| EGS | Electro galvanized steel coupon, obtained from ACT Test Panels |
| PM-38117 | Polyamine adduct which can be prepared as follows: To a 151.4 liter (L) |
| | Ross 3 shaft mixer kettle, 36.29 kilograms (kg) TTD was added, followed |
| | by 20.87 kg MX-154 (containing epoxy resin and polybutadiene core- |
| | shell rubber particles) at a temperature of between 26.7-37.7° C., and |
| | mixed under nitrogen with the anchor blade at 35 revolutions per minute |
| | (rpm) and shear blade at 700 rpm for 30 minutes. The ratio of moles of |
| | amine hydrogen (i.e., moles of reactive amine hydrogen) to moles of |
| | epoxide groups in the mixture was 6:1. The mixture was then heated to |
| | 65.6° C., and the mixture was allowed to reach its peak exotherm, |
| | approximately 87.8° C., after which the mixing continued for an |
| | additional 10 minutes. The mixture was then cooled to 48.9° C. and an |
| | additional 12.52 kg of MX-154 at 26.7 to 37.7° C. was added and mixed |
| | under nitrogen for 30 minutes. The mixture was then heated to 65.6° C. |
| | and allowed to exotherm a second time, with an additional 10 minutes of |
| | mixing after the peak temperature of the exotherm was reached. The |
| | material was then transferred into containers and sealed. The polyamine |
| | adduct composition contains the polyamine adduct of the epoxy resin, |
| | toughening agent, and residual diamine. |
| TTD | 4,7,10-trioxatridecane-1,13-diamine, obtained from BASF, Florham Park, |
| | New Jersey |
| EH 30 | A tertiary amine accelerator and curing agent for epoxy resin systems, |
| | obtained as VERSAMID EH 30 from Gabriel Phenoxies, Rock Hill, |
| | South Carolina |
| EPON 828 | An undiluted clear difunctional bisphenol A/epichlorohydrin derived |
| | liquid epoxy resin, obtained as EPON 828 from Nexeo, Woodland, Texas |
| MX-154 | Core shell rubber/epoxy resin mixture, obtained as Kane Ace MX 154 |
| | from Kaneka, Pasadena, Texas |
| Glass Beads | Acid-washed, 212-300 μm glass beads, obtained from MilliporeSigma |
| GPTMS | (3-glycidyloxypropyl)trimethoxysilane, obtained from MilliporeSigma |
| IPA | Isopropanol |

### Test Methods

### T-Peel Test Panel Surface Preparation

CRS, HDGS, and EG panels were cleaned with IPA-soaked paper towels to remove contaminants on the surface and were thoroughly dried. The IPA-cleaned panels were abraded by using 3M SCOTCH-BRITE ROLOC surface conditioning discs (A CRS grade, 07480) to remove any rust and oxide layer on the panel. The abraded panels were thoroughly cleaned with IPA-soaked paper towel to remove debris from the abrading step.

### T-Peel Test Coupon Preparation

Using a glass rod, adhesive formulation was applied evenly to the pre-cleaned surface portion of a coupon which would adhere. On top of the adhesive applied surface, another pre-cleaned coupon was placed to make a completed T-peel sample construction. This mating process was by use of small binder clips. The samples were allowed to cure at room temperature for 3 days before T-peel tests.

### T-Peel Test Measurements

T-peel tests were conducted according to ASTM D1876-08 (2015). A crosshead speed of 2 inches/min (5.1 cm/min) was used for measurement of T-peel strength. Maximum extension data was also recorded. For each formulation, 2 samples were prepared and tested.

### PREPARATORY EXAMPLES

### Adhesion Promoter Synthesis

Synthesis of 4-allyl-1,2-dihydoxybenzene

Into a 100-mL round bottom flask were placed eugenol (10.17 g) and of tris(pentafluorophenyl)-borane (0.059 g). The mixture was stirred with a magnetic stir bar until it became a homogeneous solution. Then triethylsilane (16.56 g) was slowly added to the mixture with constant stirring. During the addition, vigorous gas formation was observed. After finishing the addition, the mixture was continuously stirred at room temperature for at least 4 hours to complete the reaction. The product (silane protected 4-allyl-1,2-dihydoxybenzne) was further treated with sulfonic acid grafted polystyrene resin (AMBERLYST 15) in methanol to deprotect the silane. The resulting product was concentrated via rotary evaporation and a clear slightly yellow liquid was obtained.

### Synthesis of Adhesion Promoter A

### Thermal Route

Into a 30-mL vial were placed 4-allyl-1,2-dihydoxybenzene (1.68g), 2,2′-(ethylenedioxy)-diethanethiol (2.04 g), allyl glycidyl ether (1.28 g), ethyl acetate (5.00 g), and VAZO 67 (0.125 g). The vial was capped with a lid and the mixture was stirred with a magnetic stir bar during the reaction. The vial was heated to 70° C. for 18 hours in an oil bath. The resulting product was a clear transparent liquid.

### UV Route

The same reaction was conducted via UV irradiation. All reactants were the same except VAZO 67 was replaced with IRG 651 (0.125g). The mixture was stirred until it became a homogeneous solution and then was UV irradiated with two black UV light bulbs (Philips TL-D 15W, BLB) at a distance of about 10 inches (25 cm). The mixture was continuously stirred during the UV irradiation for at least 30 minutes to complete the reaction. The resulting product was a clear transparent liquid.

### Adhesion Promoter B

### Thermal Route

Into a 30-mL vial were placed 4-allyl-1,2-dihydoxybenzene (1.42 g), trimethylolpropane tris(3-mercaptopropionate) (2.51 g), allyl glycidyl ether (1.08 g), ethyl acetate (5.00 g), and VAZO 67 (0.125 g). The vial was capped with a lid and the mixture was stirred with a magnetic stir bar during the reaction. The vial was heated to 70° C. for 18 hours in an oil bath. The resulting product was a clear transparent liquid.

### UV Route

The same reaction was conducted via UV irradiation. All reactants were the same except VAZO 67. Was replaced with IRG 651 (0.125g). The mixture was stirred until it became a homogeneous solution then was UV irradiated with two black UV light bulbs (Philips TL-D 15W, BLB) at a distance of about 10 inches (25 cm). The mixture was continuously stirred during the UV irradiation for at least 30 minutes to complete the reaction. The resulting product was a clear transparent liquid.

### Adhesion Promoter C

### Thermal Route

Into a 30-mL vial were placed 4-allyl-1,2-dihydoxybenzene (1.48 g), pentaerythritol tetrakis(3-mercaptopropionate) (2.40 g), allylglycidyl ether (1.12 g), ethyl acetate (5.00 g), and VAZO 67 (0.125 g). The vial was capped with a lid and the mixture was stirred with a magnetic stir bar during the reaction. The vial was heated to 70° C. for 18 hours in an oil bath. The resulting product was a clear transparent liquid.

### UV Route

The same reaction was conducted via UV irradiation. All reactants were the same except VAZO 67 was replaced with IRG 651 (0.125 g). The mixture was stirred until it became a homogeneous solution then was UV irradiated with two black UV light bulbs (Philips TL-D 15W, BLB) at a distance of about 10 inches (25 cm). The mixture was continuously stirred during the UV irradiation for at least 30 minutes to complete the reaction. The resulting product was a clear transparent liquid.

### Adhesion Promoter D

Into a 30-mL vial were placed 4-allyl-1,2-dihydoxybenzene (3.27g), 1,4-bis(dimethylsilyl)benzene (4.24 g), allylglycidyl ether (2.49 g), ethyl acetate (10.00 g), and platinum divinyl tetramethyldisiloxane complex (0.05 g). The vial was capped with a lid and the mixture was stirred with a magnetic stir bar during the reaction. The vial was heated to 50° C. for 18 hours in an oil bath. The resulting product was a clear transparent liquid.

### Adhesion Promoter E

Into a 30-mL vial were placed 4-allyl-1,2-dihydroxybenzene (3.91 g), 1,4-bis(dimethylsilyl)-benzene (3.13 g), allyl glycidyl ether (2.97 g), ethyl acetate (10.00 g), and platinum divinyl tetramethyl-disiloxane complex (0.05 g) were dispensed. The vial was capped with a lid and the mixture was stirred with a magnetic stir bar during the reaction. The vial was heated to 50° C. for 18 hours in an oil bath. The resulting product was a clear transparent liquid.

### Epoxy Resin Preparation

### Part A

Into a 150-mL DAC speedmixer container were placed PM-38117 (52.09 g), 4,7,10-trioxatridecane-1,13-diamine (47.91 g), and EH 30 (3.00 g). The container was closed with a lid and placed in a high shear mixer (DAC 150 SPEEDMIXER, FlackTek, Landrum, South Carolina). The contents were mixed at 2000 rpm for 4 min. The resulting mixture was a slightly yellow opaque viscous liquid.

### Part B

Into a 150-mL DAC speedmixer container were placed EPON 828 (55.87 g) and MX-154 (44.13 g). The container was closed with a lid and was placed in a DAC 150 speedmixer. The contents were mixed at 2000 rpm for 4 min. The resulting mixture was an opaque viscous liquid.

### EXAMPLES EX-1 to EX-8 and COMPARATIVE EXAMPLES CE-A to CE-B

Into a 150-mL DAC speedmixer container were placed premixed part A (30.00 g), premixed part B (63.24 g), and glass beads (1.4 g) were dispensed. When an adhesion promoter were included, they were also placed in the container. The formulations were mixed at 2000 rpm using for 4 min. The resulting mixture was used for making T-peel test coupons. Table 2 reports compositions of Examples EX-1 to EX-8 and Comparative Examples CE-A to CE-B.

Tables 3-8 report test results for Examples EX-1 to EX-8 and Comparative Examples CE-A to CE-B.

TABLE 2

| | PART | PART | GLASS | | ADHESION |
|---|---|---|---|---|---|
| | A, | B, | BEADS, | | PROMOTER, |
| EXAMPLE | grams | grams | grams | ADHESION PROMOTER | grams |
| Comparative Example CE-A | 30.00 | 63.24 | 1.4 | None | 0 |
| Comparative Example CE-B | 30.00 | 63.24 | 1.4 | (3-glycidyloxypropyl)trimethoxysilane | 1.4 |
| | | | | (100% Solids) | |
| EX-1 | 30.00 | 63.24 | 1.4 | Adhesion Promoter A | 2.8 |
| | | | | (thermal route, 50% solids) | |
| EX-2 | 30.00 | 63.24 | 1.4 | Adhesion Promoter B | 2.8 |
| | | | | (thermal route, 50% solids) | |
| EX-3 | 30.00 | 63.24 | 1.4 | Adhesion Promoter C | 2.8 |
| | | | | (thermal route, 50% solids) | |
| EX-4 | 30.00 | 63.24 | 1.4 | Adhesion Promoter D | 2.8 |
| | | | | (50% solids) | |
| EX-5 | 30.00 | 63.24 | 1.4 | Adhesion Promoter E | 2.8 |
| | | | | (50% solids) | |
| EX-6 | 30.00 | 63.24 | 1.4 | Adhesion Promoter A | 2.8 |
| | | | | (UV route, 50% solids) | |
| EX-7 | 30.00 | 63.24 | 1.4 | Adhesion Promoter B | 2.8 |
| | | | | (UV route, 50% solids) | |
| EX-8 | 30.00 | 63.24 | 1.4 | Adhesion Promoter C | 2.8 |
| | | | | (UV route, 50% solids) | |

TABLE 3

| | | | AVERAGE | AVERAGED | |
|---|---|---|---|---|---|
| | | SAMPLE | LOAD, | AVERAGE | % IMPROVEMENT |
| EXAMPLE | PANEL | NO. | N/cm | LOAD, N/cm | (compared to CE-A) |
| CE-A | CRS | 1 | 5.48 | 5.47 | 0 |
| | | 2 | 5.46 | | |
| CE-B | CRS | 1 | 6.16 | 6.00 | 10 |
| | | 2 | 5.84 | | |
| EX-1 | CRS | 1 | 6.31 | 6.31 | 15 |
| | | 2 | 6.33 | | |
| EX-2 | CRS | 1 | 6.43 | 6.46 | 18 |
| | | 2 | 6.50 | | |
| EX-3 | CRS | 1 | 8.59 | 7.84 | 43 |
| | | 2 | 7.09 | | |
| EX-4 | CRS | 1 | 7.54 | 7.82 | 43 |
| | | 2 | 8.11 | | |
| EX-5 | CRS | 1 | 7.15 | 7.84 | 43 |
| | | 2 | 8.54 | | |
| EX-6 | CRS | 1 | 6.09 | 6.99 | 28 |
| | | 2 | 7.88 | | |
| EX-7 | CRS | 1 | 7.15 | 6.62 | 21 |
| | | 2 | 6.09 | | |
| EX-8 | CRS | 1 | 8.00 | 7.48 | 37 |
| | | 2 | 6.97 | | |

TABLE 4

| | | | MAXIMUM | AVERAGED | |
|---|---|---|---|---|---|
| | | SAMPLE | EXTENSION, | MAXIMUM | % IMPROVEMENT |
| EXAMPLE | PANEL | NO. | mm | EXTENSION, mm | (compared to CE-A) |
| CE-A | CRS | 1 | 117.19 | 118.50 | 0 |
| | | 2 | 119.81 | | |
| CE B | CRS | 1 | 117.39 | 118.32 | 0 |
| | | 2 | 119.24 | | |
| EX-1 | CRS | 1 | 124.27 | 123.95 | 5 |
| | | 2 | 123.63 | | |
| EX-2 | CRS | 1 | 128.54 | 127.10 | 7 |
| | | 2 | 125.65 | | |
| EX-3 | CRS | 1 | 130.77 | 127.90 | 8 |
| | | 2 | 125.02 | | |
| EX-4 | CRS | 1 | 121.25 | 124.75 | 5 |
| | | 2 | 128.24 | | |
| EX-5 | CRS | 1 | 119.51 | 126.94 | 7 |
| | | 2 | 134.37 | | |
| EX-6 | CRS | 1 | 104.10 | 106.96 | −10 |
| | | 2 | 109.82 | | |
| EX-7 | CRS | 1 | 118.33 | 136.07 | 15 |
| | | 2 | 153.80 | | |
| EX-8 | CRS | 1 | 122.35 | 124.04 | 5 |
| | | 2 | 125.74 | | |

TABLE 5

| | | | AVERAGE | AVERAGED | |
|---|---|---|---|---|---|
| | | SAMPLE | LOAD, | AVERAGE | % IMPROVEMENT |
| EXAMPLE | PANEL | NO. | N/cm | LOAD, N/inch | (compared to CE-A) |
| CE-A | HDGS | 1 | 1.89 | 2.11 | 0 |
| | | 2 | 2.34 | | |
| CE-B | HDGS | 1 | 2.15 | 2.20 | 4 |
| | | 2 | 2.26 | | |
| EX-1 | HDGS | 1 | 2.01 | 2.47 | 17 |
| | | 2 | 2.93 | | |
| EX-2 | HDGS | 1 | 3.09 | 2.47 | 17 |
| | | 2 | 1.84 | | |
| EX-3 | HDGS | 1 | 3.19 | 3.30 | 56 |
| | | 2 | 3.40 | | |
| EX-4 | HDGS | 1 | 2.38 | 2.56 | 21 |
| | | 2 | 2.73 | | |
| EX-5 | HDGS | 1 | 2.57 | 2.56 | 21 |
| | | 2 | 2.54 | | |
| EX-6 | HDGS | 1 | 2.22 | 2.23 | 6 |
| | | 2 | 2.24 | | |
| EX-7 | HDGS | 1 | 3.11 | 3.00 | 42 |
| | | 2 | 2.89 | | |
| EX-8 | HDGS | 1 | 2.73 | 2.76 | 31 |
| | | 2 | 2.79 | | |

TABLE 6

| | | | | AVERAGED | |
|---|---|---|---|---|---|
| | | | MAXIMUM | MAXIMUM | |
| | | SAMPLE | EXTENSION, | EXTENSION, | % IMPROVEMENT |
| EXAMPLE | PANEL | NO. | mm | mm | (compare to CE-A) |
| CE-A | HDGS | 1 | 108.00 | 120.13 | 0 |
| | | 2 | 132.26 | | |
| CE-B | HDGS | 1 | 120.62 | 122.79 | 2 |
| | | 2 | 124.96 | | |
| EX-1 | HDGS | 1 | 128.32 | 131.26 | 9 |
| | | 2 | 134.20 | | |
| EX-2 | HDGS | 1 | 139.67 | 128.55 | 7 |
| | | 2 | 117.44 | | |
| EX-3 | HDGS | 1 | 140.05 | 141.72 | 18 |
| | | 2 | 143.39 | | |
| EX-4 | HDGS | 1 | 131.03 | 136.77 | 14 |
| | | 2 | 142.50 | | |
| EX-5 | HDGS | 1 | 136.62 | 135.29 | 13 |
| | | 2 | 133.95 | | |
| EX-6 | HDGS | 1 | 135.60 | 135.79 | 13 |
| | | 2 | 135.98 | | |
| EX-7 | HDGS | 1 | 141.82 | 139.98 | 17 |
| | | 2 | 138.14 | | |
| EX-8 | HDGS | 1 | 138.06 | 135.59 | 13 |
| | | 2 | 133.11 | | |

TABLE 7

| | | | AVERAGE | AVERAGED | |
|---|---|---|---|---|---|
| | | SAMPLE | LOAD, | AVERAGE | % IMPROVEMENT |
| EXAMPLE | PANEL | NO. | N/cm | LOAD, N/cm | (compare to CE-A) |
| CE-A | EGS | 1 | 4.28 | 4.23 | 0 |
| | | 2 | 4.19 | | |
| CE-B | EGS | 1 | 4.74 | 4.43 | 5 |
| | | 2 | 4.12 | | |
| EX-1 | EGS | 1 | 6.83 | 5.61 | 33 |
| | | 2 | 4.39 | | |
| EX-2 | EGS | 1 | 6.04 | 5.87 | 39 |
| | | 2 | 5.70 | | |
| EX-3 | EGS | 1 | 6.54 | 6.50 | 53 |
| | | 2 | 6.45 | | |
| EX-4 | EGS | 1 | 3.90 | 4.27 | 1 |
| | | 2 | 4.63 | | |
| EX-5 | EGS | 1 | 4.21 | 4.82 | 14 |
| | | 2 | 5.44 | | |
| EX-6 | EGS | 1 | 4.93 | 4.33 | 2 |
| | | 2 | 3.72 | | |
| EX-7 | EGS | 1 | 8.10 | 6.56 | 55 |
| | | 2 | 5.02 | | |
| EX-8 | EGS | 1 | 6.30 | 6.26 | 48 |
| | | 2 | 6.22 | | |

TABLE 8

| | | | | AVERAGED | |
|---|---|---|---|---|---|
| | | | MAXIMUM | MAXIMUM | |
| | | SAMPLE | EXTENSION, | EXTENSION, | % IMPROVEMENT |
| EXAMPLE | PANEL | NO. | mm | mm | (compare to CE-A) |
| CE-A | EGS | 1 | 108.25 | 116.95 | 0 |
| | | 2 | 125.66 | | |
| CE-B | EGS | 1 | 117.36 | 118.05 | 1 |
| | | 2 | 118.75 | | |
| EX-1 | EGS | 1 | 128.70 | 121.02 | 3 |
| | | 2 | 113.33 | | |
| EX-2 | EGS | 1 | 131.03 | 131.56 | 12 |
| | | 2 | 132.09 | | |
| EX-3 | EGS | 1 | 136.62 | 135.29 | 16 |
| | | 2 | 133.95 | | |
| EX-4 | EGS | 1 | 117.57 | 125.31 | 7 |
| | | 2 | 133.06 | | |
| EX-5 | EGS | 1 | 129.80 | 131.73 | 13 |
| | | 2 | 133.66 | | |
| EX-6 | EGS | 1 | 121.29 | 115.73 | −1 |
| | | 2 | 110.16 | | |
| EX-7 | EGS | 1 | 143.26 | 141.38 | 21 |
| | | 2 | 139.50 | | |
| EX-8 | EGS | 1 | 136.75 | 137.00 | 17 |
| | | 2 | 137.25 | | |

The preceding description, given in order to enable one of ordinary skill in the art to practice the claimed disclosure, is not to be construed as limiting the scope of the disclosure, which is defined by the claims and all equivalents thereto.

1. An adhesion modifier composition comprising at least one of:
Compound A represented by the formula: 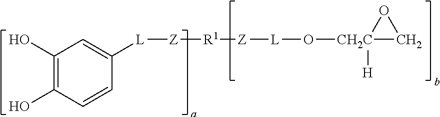
or Compound B represented by the formula: 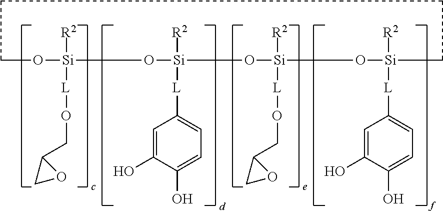
wherein:
each Z independently represents —S— or —Si(R²)₂—;
a is 1, 2, or 3;
b is 1, 2, or 3;
R¹ represents an organic group composed of C, H, and optionally O atoms, and has a free valence of
a+b;
c is 0 or 1;
each R² independently represents methyl or ethyl;
each L independently represents an alkylene group having from 2 to 6 carbon atoms;
c and d are independently 1 or 2;
e and fare independently 0 or 1, with the proviso that the sum c+d+e+f is 3 or 4.

2. The adhesion modifier composition of claim 1, wherein the adhesion modifier composition comprises Compound A.

3. The adhesion modifier composition of claim 1, wherein the adhesion modifier composition comprises Compound B.

4. The adhesion modifier composition of claim 1, wherein the adhesion modifier composition comprises Compound A and Compound B.

5. The adhesion modifier composition of claim 1, wherein a+b=4.

6. The adhesion modifier composition of claim 1, wherein R² is methyl.

7. The adhesion modifier composition of claim 1, wherein Z is represented by —S—.

8. The adhesion modifier composition of claim 1, wherein Z represents —Si(R²)₂—.

9. The adhesion modifier composition of claim 4, wherein L represents
—CH₂CH₂CH₂—.

10. The adhesion modifier composition of claim 4, wherein c is 1.

11. The adhesion modifier composition of claim 4, further comprising organic solvent.

12. A curable composition comprising:
at least one curable epoxy resin;
the adhesion modifier composition of claim 4; and
an effective amount of curative for the at least one curable epoxy resin.

13. A method of bonding a first substrate to a second substrate, the method comprising
disposing the curable composition of claim 12 between, and in intimate contact with, the first and second substrates; and
at least partially curing the curable composition.

14. The method of claim 13, wherein at least one of the first or second substrates comprises metallic zinc.

15. The method of claim 13, wherein at least one of the first or second substrates comprises steel.

16. The method of claim 14, wherein at least one of the first or second substrates comprises steel.

17. The adhesion modifier composition of claim 4, wherein a+b=4.

18. The adhesion modifier composition of claim 4, wherein R² is methyl.

19. The adhesion modifier composition of claim 4, wherein Z is represented by —S—.

20. The adhesion modifier composition of claim 4, wherein Z represents —Si(R²)₂—.
